(19) United States
(12) Patent Application Publication
(10) Pub. No.: US 2006/0200266 A1
(43) Pub. Date: Sep. 7, 2006

(54) Systems for performing parallel distributed processing for physical layout generation

(75) Inventors: Dimitris Konstantinos Fotakis, Saratoga, CA (US); Manolis M. Tsangaris, San Carlos, CA (US); Thomas W. Geocaris, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Athena Design Systems, Inc.

(21) Appl. No.: 11/315,892

(22) Filed: Dec. 22, 2005

Related U.S. Application Data
(60) Provisional application No. 60/658,164, filed on Mar. 4, 2005.

(51) Int. Cl. G06F 19/00

(52) U.S. Cl. 700/121

(57) ABSTRACT

A system for performing parallel distributed processing thereby accelerating the generation of a physical layout is disclosed. Specifically, the system significantly reduces the execution time of a place and route stage in the design of an integrated circuit (IC). An IC design is broken to multiple tiles that are independently processed and routed in parallel. This is achieved by providing an infrastructure that manages the multi-processing as well as data flows between a main computing node and a plurality of remote processing nodes.

### CROSS-REFERENCE TO RELATED APPLICATION

This application claims the benefit of U.S. Provisional Patent Application No. 60/658,164 filed Mar. 4, 2005.

### BACKGROUND OF THE INVENTION

1. Field of the Invention

The present invention relates to the field of electronic design automation (EDA) systems, and more particularly to systems for accelerating and optimizing the place and routing process in the design of an integrated circuit.

2. Prior Art

State of the art electronic design automation (EDA) systems for designing complex integrated circuits (ICs) consist of several software tools utilized for the creation and verification of designs of such circuits. Presently, EDA systems implement a design process commonly known as the top-down design methodology. This methodology is an iterative process that includes the processing tasks of logic synthesis, floor-planning, place and route, parasitic extraction, and timing optimization.

The start point of a typical top-down design flow is a register transfer level (RTL) functional description of an IC design expressed in a hardware description language (HDL). This design is coupled with various design goals, such as the overall operating frequency of the IC, circuit area, power consumption, and the like.

Conventional top-down methodology uses two processes, a front-end flow, and a back-end flow. Each of these flows involves multiple, time consuming, iterations and the exchange of very complex information. In the front-end of the top-down methodology, the RTL model is manually partitioned by a designer into various functional blocks that represent the functional and architectural characteristics of the design. The functional blocks are then converted by logic synthesis tools into a detailed gate level netlist. A synthesis tool further determines the timing constraints based on a statistical wire-load estimation model and a pre-characterized cell library for the process technology to be used when physically implementing the IC.

The gate-level netlist and timing constraints are then provided to the back-end flow to create a floor-plan, and then to optimize the logic. The circuit is then placed and routed by a place-and-route tool to create the physical layout. Specifically, the objective of the routing phase is to complete the interconnections between design blocks according to the specified netlist while minimizing interconnect area and signal delays. First, the space not occupied by blocks is partitioned into rectangular regions called channels and switch boxes. Then, a routing tool determines all circuit connections using the shortest possible wire length. Routing is usually preformed in two phases, referred to as the global and detailed routing. Global routing specifies the loose route of a wire through different regions of the routing space. The detailed routing completes point-to-point connections between terminals of the blocks. To limit the number of iterations of the placement algorithm, an estimate of the required routing space is used during the placement phase. A good routing and circuit performance heavily depends on a good placement algorithm. This is due to the fact that once the position of each block is fixed, there is little room for improving the routing and overall circuit performance.

The number of possible placements in a typical IC is extremely large. In fact for an IC design, with N blocks, the number of possible arrangements is N factorial (N!), and the complexity of the problem is NP-hard. Placement algorithms function by generating large numbers of possible placements and comparing them in accordance with some criteria, such as the overall chip size and the total wire length of the IC.

Generally, after place-and-route, parasitic extraction and timing optimization tools feed timing data back to the logic synthesis process so that a designer can iterate on the design until the design goals are met.

As mentioned above, the design flow involves multiple, time consuming iterations and transfer of complex data, especially during the place and route stage. For this reason, the design of ICs is performed using computers capable of processing multiple tasks, and allowing concurrent data access by multiple users. Nevertheless, such computer systems are not designed to uniquely execute place and route related tasks. It therefore would be advantageous to provide a system for accelerating the generation of a physical layout by performing parallel distributed processing of routing tasks.

### BRIEF DESCRIPTION OF THE DRAWINGS

FIG. 1 is a non-limiting and exemplary diagram of a distributed processing system disclosed in accordance with the present invention.

FIGS. 2A and 2B are non-limiting and exemplary TCL scripts executed by the system disclosed by the present invention.

FIG. 3 is an exemplary ladder diagram describing the operation of the publish-and-subscribe protocol in accordance with an embodiment of the present invention.

FIG. 4 is a ladder diagram describing the principles of the distributed multi-processing in accordance with an embodiment of this invention the present invention.

### DETAILED DESCRIPTION OF THE PREFERRED EMBODIMENTS

Disclosed is a system that significantly reduces the execution time of the place and route stage for the physical implementation of a design of an integrated circuit (IC). The system breaks the design to multiple tiles that are independently processed and routed in parallel. This is achieved by providing an infrastructure that manages the multi-processing as well as data flows between a main computing node and a plurality of remote processing nodes. The tiles are of a variable size and aspect ratios.

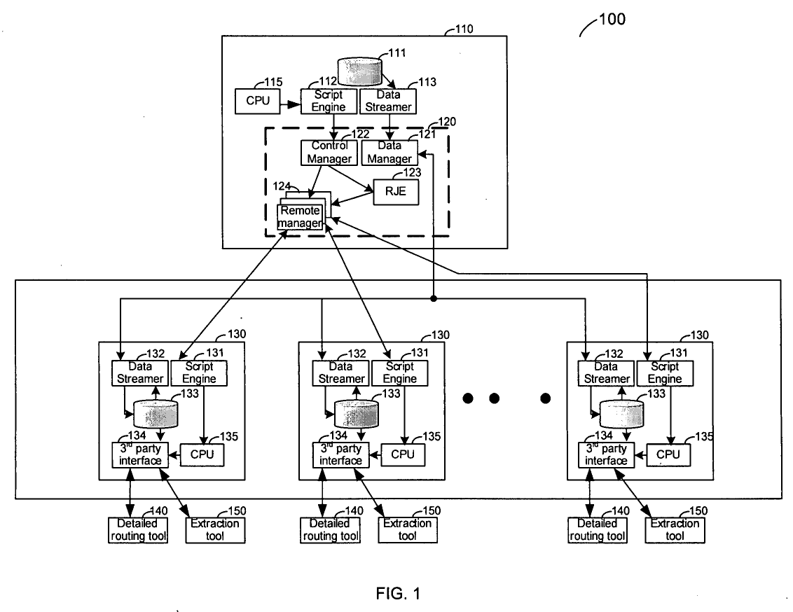

Now referring to FIG. 1, a non-limiting and exemplary diagram of a distributed processing system 100, disclosed in accordance with the present invention, is shown. System 100 comprises a main computing node 110 coupled to a plurality of remote processing nodes 130. The main computing node 110 includes a main database 111 for holding design information, a script engine 112 for propagating scripts to be executed by remote processing nodes 130, a data streamer 113 for transferring binary data streams to remote processing nodes 130, and a multi-processing agent (MPA) 120. In addition, main computing node 110 preferably includes a central processing unit (CPU) 115 for executing various of the processing tasks. MPA 120 is the infrastructure that enables the distributed parallel processing and includes a data manager 121, a control manager 122, a remote job execution (RJE) unit 123, and a plurality of remote managers 124. Each of the remote managers 124 is allocated by RJE unit 123 to control processes executed by remote processing nodes 130. RJE unit 123, e.g., a load sharing facility (LSF) is a general purpose distributed queuing system that unites a cluster of computers into a single virtual system to make better use of the resources available on the network. RJE unit 123 can automatically select resources in a heterogeneous environment based on the current load conditions and the resource requirements of the applications. Control manager 121 manages distributed processing resources. Data manager 122 controls the processes of transferring data streams from and to remote processing nodes 130. The process for transferring data flow is described in greater detail below.

Each of remote processing nodes 130 includes a remote script engine 131, a remote data streamer 132 for receiving and transforming data streams, a remote database 133 for maintaining blocks of information, and a third party interface 134 capable of interfacing with at least a detailed routing tool 140 and an extraction tool 150. A remote processing node 130 preferably includes a CPU 135 having its own operating system and being capable of performing various processing tasks. In some embodiments, each remote processing node 130 may include multiple CPUs. Remote processing nodes 130 are part of a computer farm where workload management for achieving the maximum utilization of computing resources is performed by MPA 120. The communication between main computing node 110 and a remote processing node 130 is performed over a network, such as, but not limited to, a local area network (LAN).

The acceleration and optimization of the routing process is achieved by dividing a detailed routing task into multiple parallel routing sub-tasks. Specifically, a geometric tiling algorithm breaks the design, saved in main database 111, into non-overlapping layout tiles (sometimes also referred to as blocks). Each such tile includes thousands of nets. A net is a set of two or more pins that are connected, and thus connecting the logic circuits having the pins. Tiles are transferred as data streams to remote processing nodes 130. Each of nodes 130 receives the data streams and routes the tile using an external detailed routing tool 140. Once routing is completed, only incremental routed data is sent back to main computing node 110 as a data stream. The pieces of incremental routed data received from remote processing nodes 130 are merged and saved in main database 111.

Main database 111 is independent of the type or configuration of main computing node 110. Main database 111 includes a plurality of tables, where each table represents a class of objects. In addition, main database 111 uses table-indexes to represent persistent pointers. These indexes are used to implement schema relationships, where each database object has a corresponding table-index. The table-index is relative to the table that contains an object. Specifically, a table-index consists of a page-number field and a page-offset field, wherein the number of bits in each of these files is a configurable parameter. The inventors have noted that by using table-indexes instead of pointers significantly reduce the memory size of main database 111. Low size memory is fundamental in EDA tools where the database's memory size ought to fit into the physical memory of the computing nodes (e.g., node 110).

Main database 110 is designed to facilitate the streaming of data to and from the main database 110. For that purpose, all tables in main database 111 can be individually streamed to any stream-source, such as a file or socket. The streaming is enabled by the use of proprietary operators that are responsible for writing the persistent contents of an object to data streamer 113. The utilization of these operators and the use of table-indexes allow streaming data without translating pointers from or to their physical addresses. Furthermore, the ability to stream tables separately reduces the amount of network traffic and thus improves the performance of system 100. That is, once a remote processing node 130 modifies only a subset of data that originally was sent, then only the modified tables need to be retrieved.

To facilitate streaming efficiency, the main database 110 can be streamed at any level of desired detail. While typically the granularity of streaming is the database table. Because of the table-indexing architecture, sub-sets of table objects, single objects, or fields of objects can be sent to or received from a stream source. It should be noted that the capabilities of the main database 110 are also applicable to remote databases 133. It should be further noted that each element of main computing node 110 and remote processing node 130 can be implemented in hardware, software, firmware, middleware or a combination thereof and utilized in systems, subsystems, components, or sub-components thereof. When implemented as a program, the elements of the present invention are the instructions or code segments which, when executed, will perform the necessary tasks. The instructions or code segments can be stored in a machine readable medium (e.g. a processor readable medium or a computer program product), or transmitted by a computer data signal embodied in a carrier wave, or a signal modulated by a carrier, over a transmission medium or communication link. The machine-readable medium may include any medium that can store or transfer information in a form readable and executable by a machine (e.g. a processor, a computer, and the like). Examples of the machine-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, and the like. The instructions or code segments as well as information such as data, commands, acknowledgements, etc. may be downloaded and or communicated via networks such as the Internet, Intranet, a wide area network (WAN), a local area network (LAN), a metro area network (MAN), and the like.

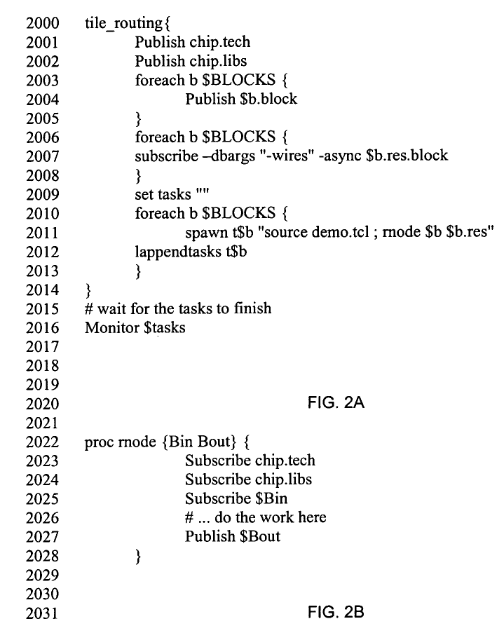

A user can execute tasks on system 100 using targeted scripts through an application specific graphic user interface (GUI). The GUI allows executing, monitoring, and debugging processes executed either on main computing node 110 or remote processing nodes 130. The targeted scripts are simple tool command language (TCL) script commands. TCL-commands include, but are not limited to, “load”, “tiling”, “tile_routing”, and “do monitoring”. Each such command activates a respective script that includes data management and multi-processing application programming interface (API) op-codes. The scripts executed by the present invention may be written in any scripting language including, but not limited to, TCL, Perl, Java-script, and others. FIG. 2A shows a non-limiting and exemplary TCL script that carries out the “tile_routing” command in accordance with one embodiment of this invention. This script reads tiles from main database 111 and sends each tile to one of remote processing nodes 130. Furthermore, for each tile a task is created and sent to the respective remote processing node. As shown in FIG. 2A, the script includes two op-codes for data transfers “publish” and “subscribe” (shown in lines 2001, 2002, 2004 and 2007) and two op-codes for multi-processing “spawn” (shown in line 2011) and monitor (shown in line 2016). FIG. 2B is a script executed on a remote processing node 130.

MPA 120 assigns tasks to be executed by remote processing nodes 130 using control manager 122. Tasks waiting to be executed are kept in a system queue (not shown) in main computing node 110. Control manager 122 interfaces with the system queue and dispatches a task to remote node 130 without any latency. A task is defined as a function applied to an input dataset and returns, as a result, an output dataset. The input dataset may be a cell library, or a tile. The output dataset may be the incremental routed data and updates made to a cell library. For that purpose, control manager 122 implements the op-code “spawn” which assigns a task to a remote node 130. Once the task is completed, the computing resource is released. Control manager 122, by implementing the monitor op-code, allows monitoring the status of an executed task (e.g., started, completed or failed). The monitor op-code further supports fork/join parallelism techniques. Fork/Join parallelism, is the simplest and most effective design technique for obtaining improved parallel performance. The fork operation starts a new parallel fork task, while the join operation causes the current task not to proceed until the forked task has completed.

As mentioned above, a tile sent to a remote processing node 130 encapsulates thousands of nets and typically comprises hundreds of megabytes of data. For instance, the size of a typical tile is approximately 300 megabytes. Fast data transfers over the network are achieved using data manager 121. Data manager 121 acts as a multi-processing data server and manages the transfers of data streams from main computing node 110 to a remote processing node 130 (and vice versa). Specifically, data manager 121 transfers datasets using a proprietary protocol which implements the two op-codes publish and subscribe.

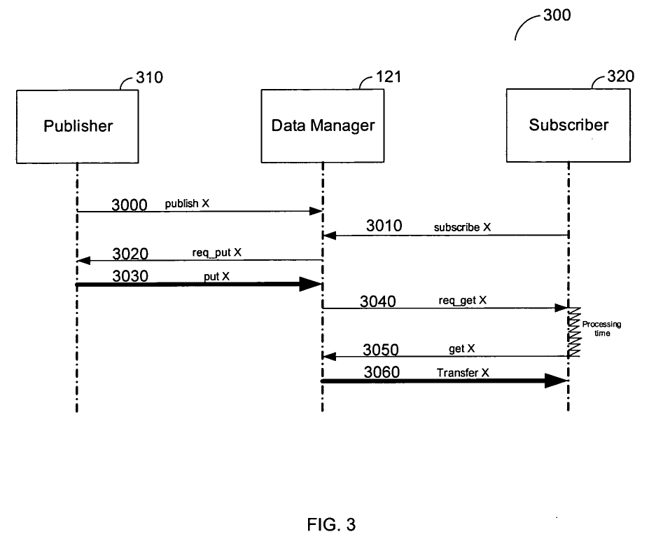

FIG. 3 shows an exemplary ladder diagram 300 describing the operation of the publish-and-subscribe protocol in accordance with an embodiment of the present invention. The protocol is used for transferring an input dataset X from a publisher 310 (e.g., main computing node 110) to a subscriber 320 (e.g., a remote processing node 130) through data manager 121. At 3000, publisher 310 informs data manager 121 that a dataset X, using the op-code “publish X”, is ready to be transferred and as a result, data manager 121 registers the publish request. At 3010, subscriber 320 requests to subscribe to the dataset X using the op-code “subscribe X”. This request may be generated by a script executed in a remote node 130. Consequently, data manager 121 registers the subscribe request, making data manager 121 ready to initiate a connection between publisher 310 and subscriber 320. At 3020, data manager 121 initiates the process for transferring data by requesting, using a “req_put” command, dataset X from publisher 310. Immediately after that, at 3030, publisher 310 transfers dataset X to data manager 121, using a “put” command. Namely, dataset X is retrieved from main database 111 and temporarily kept in the memory of data manager 121. At 3040, data manager 121 informs subscriber 320 that dataset X is ready by sending a “req_get” command. After some processing time, at 3050 subscriber 320 sends a “get” command to obtain dataset X and, at 3060, data manager 121 transfers the data to subscriber 320. As depicted in FIG. 1, data manager 121 is part of main computing node 110 and holds dataset X temporarily in its cache memory.

It should be noted that the publish-and-subscribe protocol is further used to transfer an output dataset Y (e.g., incremental routed data) from a remote processing node 130 to main computing node 110. In such a case, remote node 130 acts as publisher 310 and main node 110 acts as subscriber 320.

The publish-and-subscribe protocol can be operated in conjunction with data streaming techniques as well as with a network file system (NFS). When using the NFS, the put and get commands are replaced with write and read file system commands. Namely, a transfer of a dataset from publisher 310 to data manager 121 is performed by writing the dataset to a file server and a transfer of a dataset from data manager 121 to subscriber 320 is performed by reading the dataset from a file server. However, the inventors have noted that for routing applications, the preferred technique is data streaming. In such applications large amounts of data is transferred at high rate to multiple remote processing nodes at the same time. Therefore, using NFS requires writing and reading files from a file server. In a NFS, a file server is a shared resource accessible by all users, and thus may become the bottleneck of the parallel distributed processing. By data streaming, data is transferred directly from data manager 121 to the remote processing nodes 130. The only limitation in this case is the network's bandwidth. Data streaming provides additional advantages, such as minimizing storage requirements and dynamically regulating data stream rates for the purpose of network load control. Specifically, data manager 121 can shape the data traffic to and from the remote nodes 130 and main computing node 110, and thus controlling the rate of inbound and outbound connections. This is performed mainly for two objectives: a) limiting the number of simultaneous data set transfers, and b) reducing the peak capacity utilized by each network link. As an example, for a multi-processing level of 100 tasks, the number of data set transfers may be limited to 20 and the per network link traffic may be reduced to 50 MB/sec (half of the link capacity).

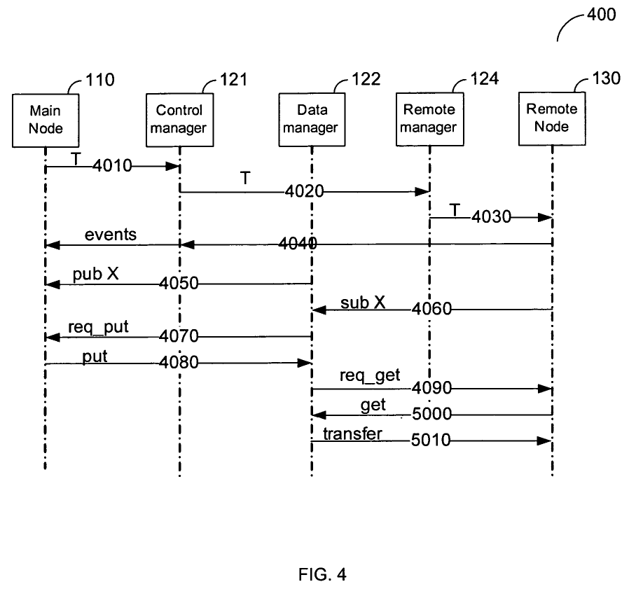

Referring to FIG. 4, an exemplary ladder diagram 400 describing the principles of the distributed multi-processing in accordance with the present invention is shown. Prior to the execution of any task over a remote processing node 130, a remote manager 124 is allocated by RJE unit 123. A single remote manager 124 is allocated per a remote processing node 130. If there are multiple CPUs on a single remote processing node 130, then multiple remote managers 124 may be allocated. At 4010, a task T is created by main computing node 110 through the spawn op-code. As a result, at 4020, control manager 122 forwards task T to the allocated remote manager 124. At 4030, a copy of the task T is created on remote processing node 130 by remote manager 124. At 4040, events generated during task execution are passed through control manager 122 and monitored by main computing node 110 using the op-code monitor. These events may be, for example, task successfully completed, task failed, task aborted, task is waiting for data, and so on. At 4050, main computing node 110 submits a request to publish a dataset X. At 4060, during the execution of a script, remote processing node 130 subscribes dataset X. Then, at 4070 through 5010 the dataset is transparently transferred from main computing node 110 to remote processing node 130 through data manager 121 using the publish-and-subscribe protocol described in greater detailed above.

The present invention has been described with reference to a specific embodiment where a parallel distributed processing of a routing application is shown. However, a person skill in the art can easily adapt the disclosed system to perform execute other specific targeted applications that require parallel distributed processing.

What is claimed is:

1. A distributed system for accelerating the generation of a physical layout of an integrated circuit (IC) design, said system comprising:
a main computing node having at least a multi-processing agent for enabling a distributed parallel processing of tasks;
a plurality of remote processing nodes coupled to said main computing node for executing the tasks assigned by said multi-processing agent; and
a communication network for communication between said main computing node and said plurality of remote processing nodes.

2. The system of claim 1, wherein said main computing node further comprises:
a main database for holding information related to said IC design;
a script engine for propagating scripts to be executed by said remote processing nodes; and
a data streamer for transferring data streams to each of the remote processing nodes.

3. The system of claim 2, wherein said main database includes a plurality of tables to maintain data of said IC design.

4. The system of claim 3, wherein the content of each table is individually streamed.

5. The system of claim 3, wherein the content of said main database is indexed using table-indexes.

6. The system of claim 1, wherein said multi-processing agent comprises:
a data manager for controlling the transfers of data streams from said main computing node to said remote processing nodes, said data manager being further controlling the transfers of data streams from said remote computing nodes to said main computing node;
a control manager for managing the distributed parallel processing of tasks;
a plurality of remote managers for controlling tasks executed on said remote processing nodes; and
a remote job execution (RJE) for allocating at least one remote manager for executing a task.

7. The system of claim 6, wherein said control manager further dispatches a task waiting in a system queue to one of said remote computing nodes.

8. The system of claim 7, wherein said task is a function applied on an input dataset and said remote computing node returns an output dataset.

9. The system of claim 8, wherein said function comprises performing a detailed routing on said tile, wherein said input dataset is a tile, and wherein said output dataset is incremental routed data.

10. The system of claim 9, wherein said tile comprises multiple nets of said IC design.

11. The system of claim 9, wherein the data streams transferred by said data manager are at least input datasets.

12. The system of claim 11, wherein the data streams received by said data manager are also at least output datasets.

13. The system of claim 12, wherein the datasets are transferred using a subscribe op-code and a publish op-code.

14. The system of claim 13, wherein said publish op-code informs said data manager that a dataset is ready to be transferred by said main computing node.

15. The system of claim 13, wherein said subscribe op-code informs said data manager that a dataset is ready to be retrieved by said remote processing node.

16. The system of claim 13, wherein said publish op-code informs said data manager that a dataset is ready to be transferred by said remote processing node.

17. The system of claim 13, wherein said subscribe op-code informs said data manager that a dataset is ready to be retrieved by said main computing node.

18. The system of claim 8, wherein said control manager implements at least one op-code for controlling the execution of said task.

19. The system of claim 18, wherein said op-code including at least one of: a monitor op-code for monitoring the status of a task, and a spawn op-code for assigning a task to one of said remote processing nodes.

20. The system of claim 1, wherein each of said remote processing nodes comprises at least:
a remote script engine for handling scripts received from said main computing node;
a remote data streamer for receiving data streams from said main computing node and for transferring data streams to said main computing node;
a remote database for maintaining information on a routed tile; and
a third party interface for interfacing with at least an external design tool.

21. The system of claim 20, wherein said design tool is at least one of: a detailed routing tool, and an extraction tool.

22. The system of claim 20, wherein said remote processing nodes are part of a computing farm.

23. The system of claim 1, wherein said communication network is at least one of: a wide area network (WAN), a location area network (LAN), and a metro area network (MAN).

24. A method for accelerating the generation of a physical layout of an integrated circuit (IC) design, said method comprising:
allocating a remote manager;
creating a task by a main computing node;
forwarding said task to the allocated remote manager;
creating a copy of said task on a remote processing node using said remote manager;
publishing a request to transfer a dataset using a data manager;
subscribing said request in said remote processing node; and
transferring said dataset from said main computing node to said remote processing node.

25. The method of claim 24, wherein the method further comprises monitoring the execution of said task.

26. The method of claim 25, wherein monitoring said task is performed using a monitor op-code.

27. The method of claim 24, wherein creating said task is performed using a spawn op-code.

28. The method of claim 24, wherein said dataset includes information related to said task.

29. The method of claim 28, wherein said dataset is transferred as a data stream.

30. The method of claim 29, wherein said dataset includes multiple nets of said tile.

31. The method of claim 24, wherein said task comprises performing a detailed routing on a tile.

32. The method of claim 24, wherein subscribing said request is performed using a subscribe op-code.

33. The method of claim 24, wherein publishing said request is performed using a publish op-code.

34. The method of claim 24, the method further comprising:
upon completing the execution of said task by said remote processing node, sending incremental routed data from said remote processing node to said main computing node; and
saving said incremental routed data in a main database.

35. A machine-readable medium that provides instructions to implement a method for accelerating the generation of a physical layout of an integrated circuit (IC) design, which instructions, when executed by a set of processors, cause said set of processors to perform operations comprising:
allocating a remote manager;
creating a task by a main computing node;
forwarding said task to the allocated remote manager;
creating a copy of said task on a remote processing node using said remote manager;
publishing a request to transfer a dataset using a data manager;
subscribing said request in said remote processing node; and
transferring said dataset from said main computing node to said remote processing node.

36. The machine-readable medium of claim 35, wherein the method further comprises monitoring the execution of said task.

37. The machine-readable medium of claim 36, wherein monitoring said task is performed using a monitor op-code.

38. The machine-readable medium of claim 35, wherein creating said task is performed using a spawn op-code.

39. The machine-readable medium of claim 35, wherein said dataset includes information related to said task.

40. The machine-readable medium of claim 39, wherein said dataset is transferred as a data stream.

41. The machine-readable medium of claim 40, wherein said dataset includes multiple nets of said tile.

42. The machine-readable medium of claim 35, wherein said task comprises performing a detailed routing on a tile.

43. The machine-readable medium of claim 35, wherein subscribing said request is performed using a subscribe op-code.

44. The machine-readable medium of claim 35, wherein publishing said request is performed using a publish op-code.
